(19) United States
(12) Patent Application Publication
(10) Pub. No.: US 2002/0072924 A1
(43) Pub. Date: Jun. 13, 2002

(54) Lost property system

(75) Inventor: Leslie Gray, Stroud (GB)

Correspondence Address: BEYER WEAVER & THOMAS LLP, P.O. BOX 778, BERKELEY, CA, 94704-0778, US

(73) Assignee: Recipero. com Ltd.

(21) Appl. No.: 09/935,784

(22) Filed: Aug. 20, 2001

(30) Foreign Application Priority Data
Aug. 19, 2000 (GB) 0020446.1

(51) Int. Cl. G06F 7/00

(52) U.S. Cl. 705/1; 707/1

(57) ABSTRACT

The computer implemented lost property locating method and system allow an owner of an item of lost property bearing an item identifier, and which has been found by a finder, to be notified that the item has been found. The owner registers the item identifier with a computer system. The finder searches the computer system for the item identifier to determine if an item having the item identifier has been registered. The computer system notifies the owner that the item has been found if the item identifier is found.

The present invention relates to a lost property system and method, and in particular to a computer implemented system and method by which the owner of an item can reclaim the lost item from the finder of the item.

Lost property facilities have been provided by various organisations to look after property that has been lost within the remit of that organisation, e.g. on a train, in a shop or in a museum. However, the success of such a system depends entirely on the loser of the property being aware of when or where the property was lost, so that they can contact the correct lost property facility.

Further, there is no central lost property facility which caters for the eventuality that the property is lost in a place for which there is no easily identifiable organisation responsible, e.g. public places. Although the police can provide some lost property facilities, the facility is geographically limited such that it is still necessary to know where the property was lost so as to be able to contact the correct police department or station.

The miniaturisation of electronics has lead to an increasing number of portable devices which are very expensive, such as cellular telephones, personal digital assistants and portable computers. The return of such expensive items to the owner is clearly desirable. Further, owing to the value of these items, they are often insured and if lost, the insurance company may have to settle a claim by the owner under their insurance policy. In such circumstances, the insurance company becomes the owner of the lost property, but has no easy way of reclaiming the property, if found. Further, some individuals may attempt to fraudulently claim ownership of an item of lost property, or to defraud an insurance company by filing an invalid insurance claim.

Hence, there is a need for a secure system by which the correct owner of an item of lost property can be notified that their property has been found, irrespective of where or when the property was lost.

According to a first aspect of the present invention, there is provided a computer implemented lost property locating method by which an owner of an item of lost property bearing an item identifier which is found by a finder can be notified that the item has been found, the method including the steps of the owner registering the item identifier with a computer system; the finder searching the computer system for the item identifier to determine if an item having the item identifier has been registered; and the computer system notifying the owner that the item has been found if the item identifier is found.

As the computer system mediates the information that an item has been lost and that the item, as identified by the item identifier has been found, the method provides an anonymous system. This helps to ensure that only parties that have genuinely lost items of property, and so only they would be aware of the fact, are notified that an item corresponding to their lost item has been found. This prevents parties from merely searching through postings of found property to fraudulently claim back property which was not originally theirs. Further, the identity of the owner of the property is not disclosed to the finder, until the finder acknowledges that the found item is the lost item.

The computer system can be accessible over a computer network, and preferably is accessible over the Internet. In this way, a central lost property locating facility can be provided which is not geographically limited. Any loser or finder of property who is registered with the facility can utilize the facility to locate lost property irrespective of where or when the property was lost.

Preferably, the owner registers at least one further item identifier. The registration of a further item identifier helps to prevent the fraudulent registration of items of property. For instance, an identification or serial number for an item of property could be made up by a fraudulent user. However, the system can include sets of rules to determine whether the further item identifiers and item identifier are valid. For instance a certain manufacturer may use a certain number of digits in a serial number for their products and this can be checked by the computer system by processing the item identifiers with regard to rules stored therein. The item identifier can be any unique identifier for the item. The item identifier can be a serial number or any other number that uniquely identifies the item.

The at least one further item identifier can be any item identifier that is borne by the item. For instance the item identifier can be a manufacturer identifier, a model identifier, a colour identifier or a trade mark identifier. A lot of products have at least two permanently borne identifiers which can be used to verify the identity of the item.

Preferably, if the item identifier is found by the computer system, the finder determines whether the at least one further identifier corresponds to the item found, and if not the computer system does not notify the owner. In this way, the finder can verify that the item identifier relates to the same item as the found item. For instance, in the event that the item identifier is incorrectly or incompletely registered by the owner, upon searching the database, the finder can compare the further item identifier registered by the owner with the item in the finders keeping to validate the identity of the item found. This can also help if the same identifier corresponds to different items.

Preferably, the owner notifies the computer system that the lost article is the subject of an insurance policy and the computer system up-dates an insurance record for the article. In this way, should the article subsequently be found, the insurance company holding the policy can be notified.

The method can include the step of the owner supplying insurance data to the computer system and the computer system recording the insurance company associated with the insurance data as the owner of the property. The computer system can determine from the insurance data the insurance company providing the policy under which the item has been replaced so as to record the insurance company as the owner of the item replaced under the policy.

Preferably, the method includes the step of recording search data for each finder search carried out by a finder. By recording the date of a search and item identifier searched for, the method can provide improved identification of potentially fraudulent lost property claims.

Preferably, the step of registering the item identifier includes determining whether the item identifier has been the subject of a finder search by a finder within a specified period. Preferably, the specified period is a period before the time of registering the item identifier. If the item identifier being registered has already been the subject of a finder's search, then the computer system can generate an indication that the item registration is possibly fraudulent.

Preferably, the method includes the step of determining if the finder search was carried out before the owner registered membership with the computer system, and if it was, the computer system generating an indicator that registration is probably fraudulent. This helps to identify instances in which the lost property has been found before the alleged owner registered their membership of the system with the facility. It provides an indicator that it is likely that the person registering the item was not the original owner.

Preferably, the method includes the step of issuing a security warning if the finder search was carried out within a specified period.

According to a second aspect of the present invention, there is provided a computer implemented lost property locating system, in which an owner of an item of lost property bearing an item identifier which is found by finder can be notified that the item has been found, and the system including processing means under a searchable database of item identifiers, in which the owner transmits the item identifier to the computer system which stores the item identifier in the database, the database is searchable by an item identifier by the finder to carry out a finder search to determine if an item having the item identifier has been registered, and the processing means notifying the owner that the item has been found if the item identifier is found by the finder search.

The database can include fields storing owner identifiers and item identifiers associated with the owner identifier. Preferably, the database also includes fields storing further item identifiers associated with the owner identifiers.

Preferably, the computer system includes a database storing finder search data, including fields for storing item identifiers and data indicating the date of a finder search for that item identifier.

Preferably, the computer system is accessible over a computer network, more preferably the Internet. The lost property system can be provided as an Internet website, which may be accessible via a computer.

According to a third aspect of the present invention there is provided a computer readable medium bearing instructions executable on a computer to carry out a method or provide a system according to the first and second aspects of the invention.

According to a fourth aspect of the present invention there is provided a computer program executable on a computer system to carry out a method or provide a system according to the first and second aspects of the invention.

An embodiment of the present invention will now be described in detail, by way of example only, and with reference to the accompanying drawings, in which:

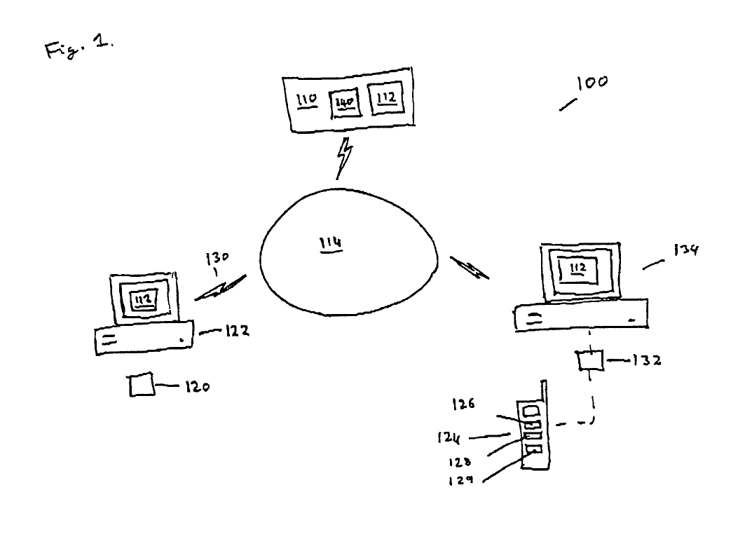

FIG. 1 shows a schematic diagram illustrating the lost property system according to the invention;

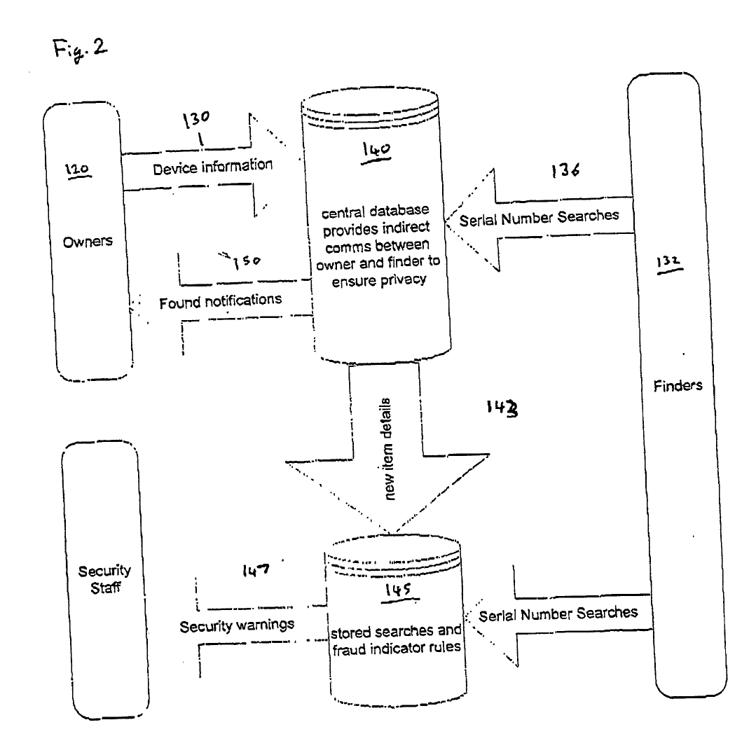

FIG. 2 shows a diagram illustrating the functional relationship between the parts and users of the system;

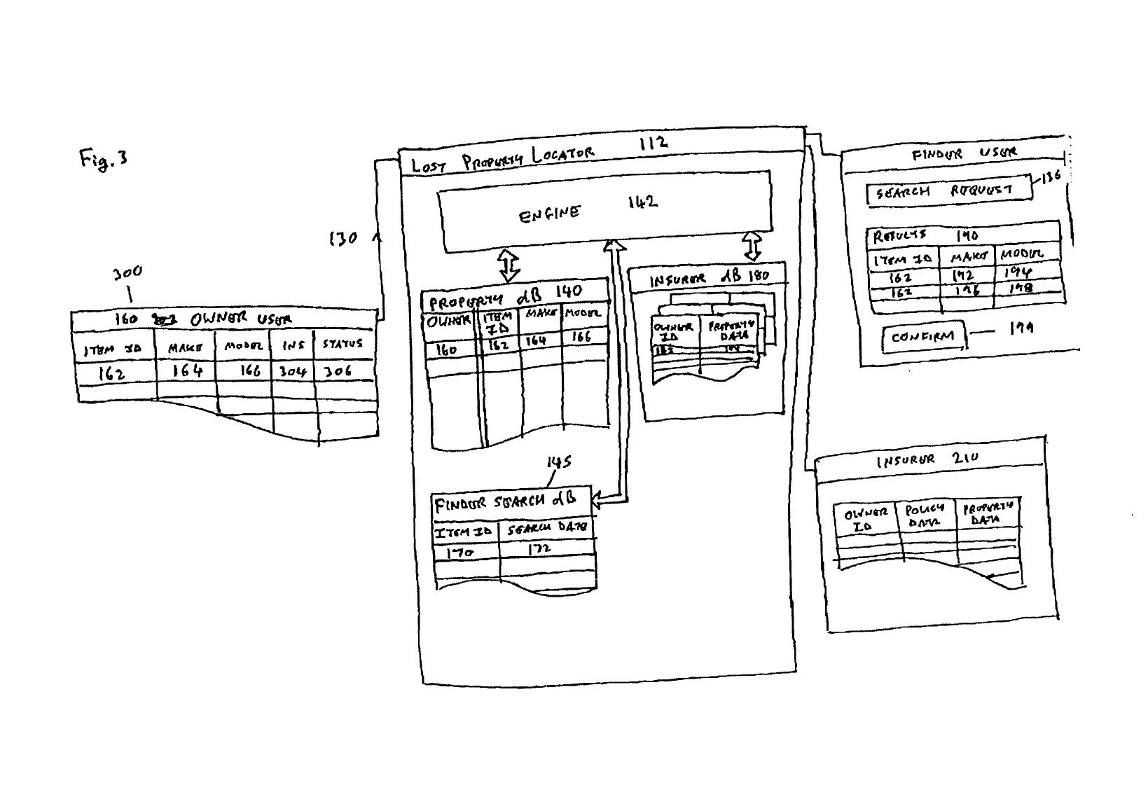

FIG. 3 shows a schematic functional diagram of the system;

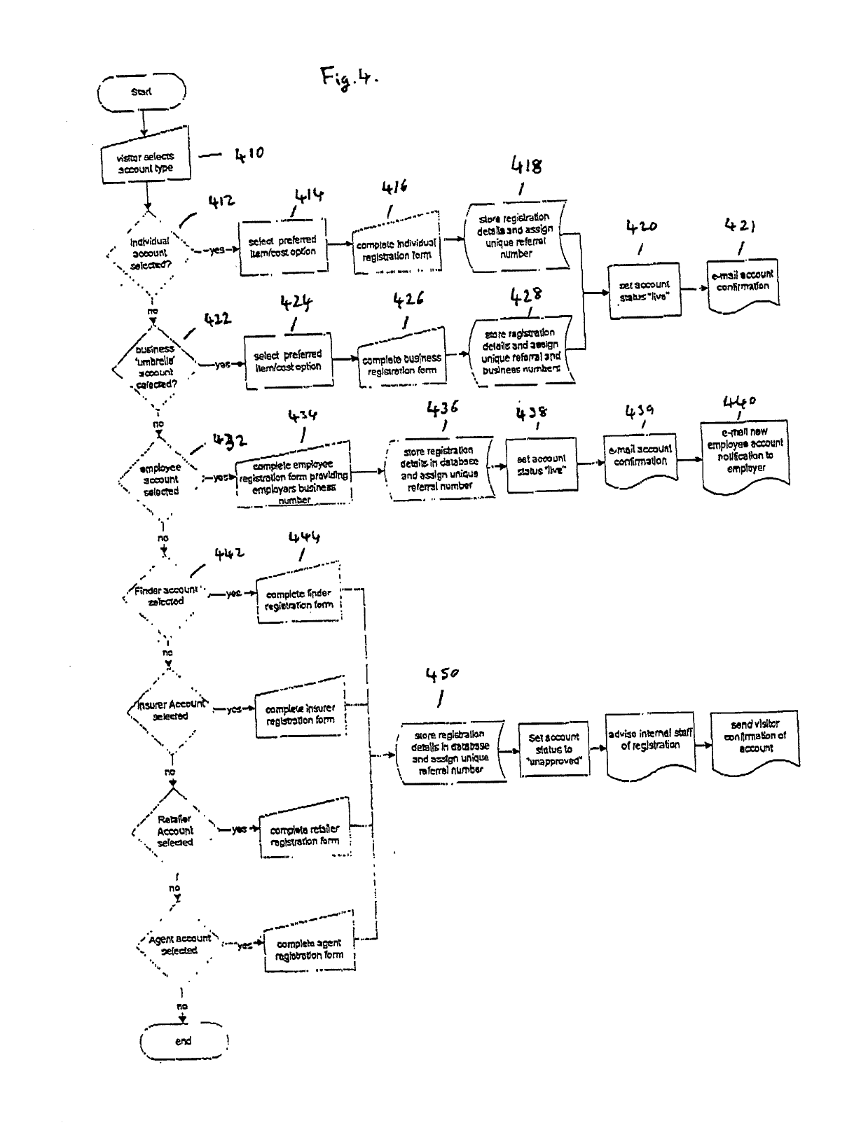

FIG. 4 shows a flow chart illustrating various user registration procedures;

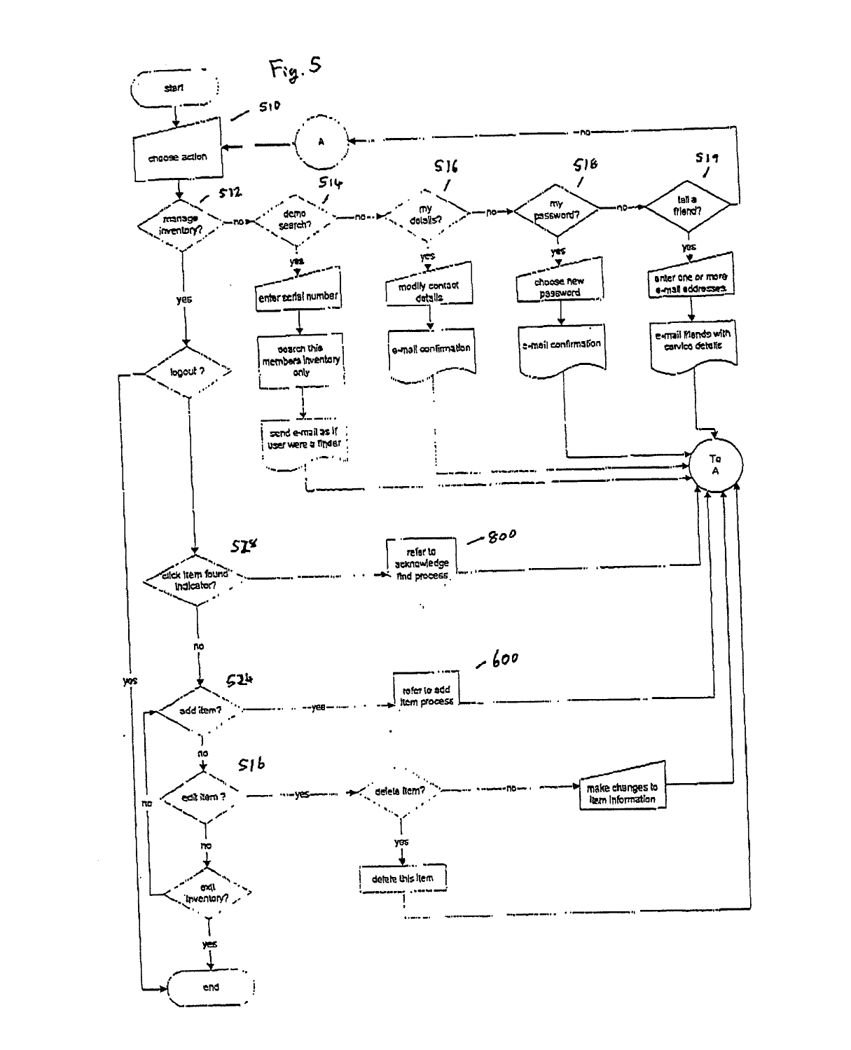

FIG. 5 shows a flow chart illustrating owner user processes supported by the system;

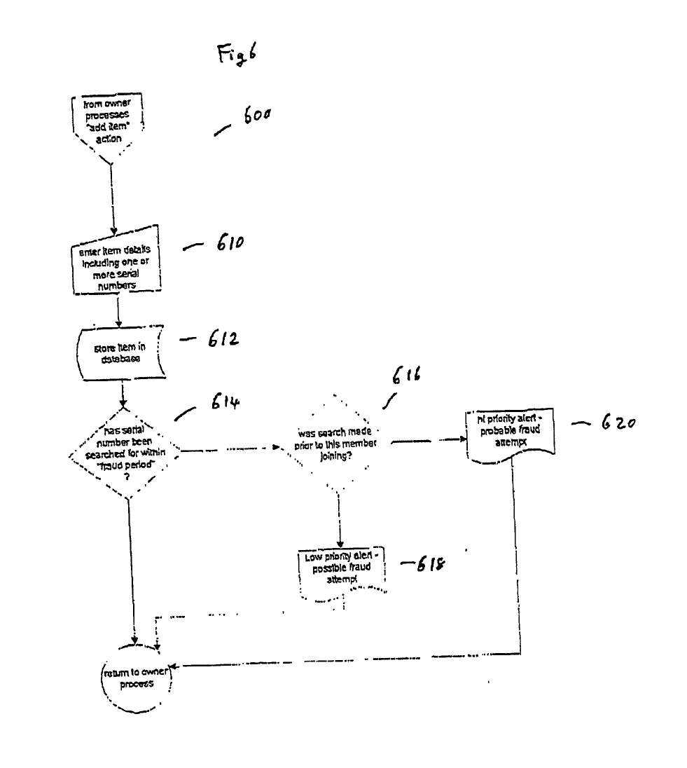

FIG. 6 shows a flow chart illustrating an “add item” action from the owner user processes of FIG. 5;

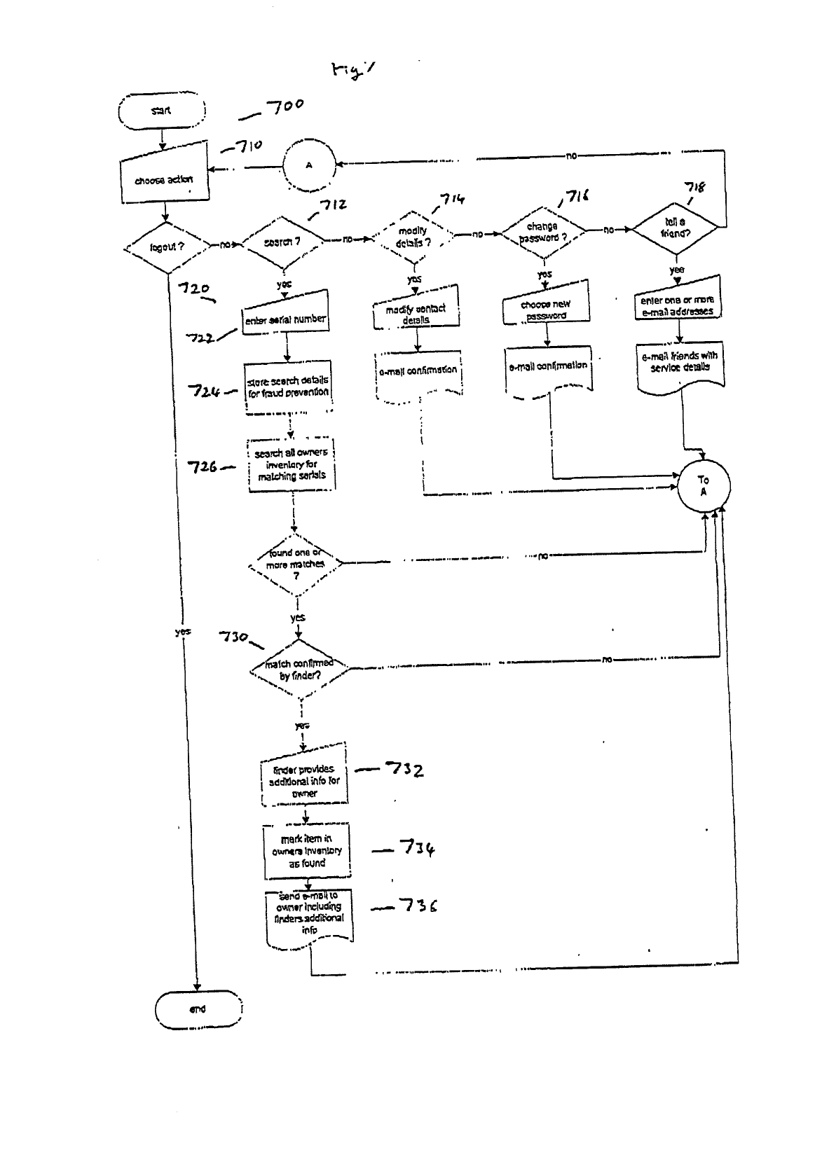

FIG. 7 shows a flow chart illustrating finder user processes supported by the system; and

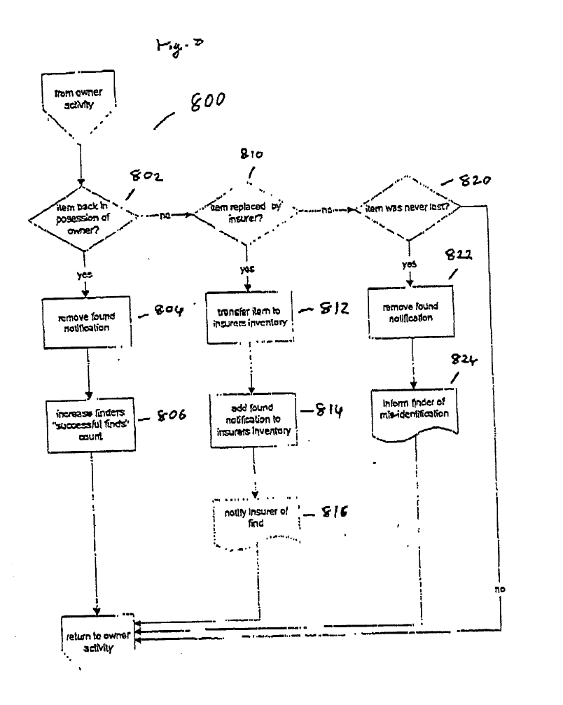

FIG. 8 shows a flow chart illustrating a “find acknowledgement” process supported by the owner processes shown in FIG. 5.

The same elements in different Figures share common reference numerals unless indicated otherwise. In the figures, the grouping together of functions and operations is not meant to indicate a physical grouping of functions and operations, but merely to clarify their common nature.

It is considered that the computer program code to implement the method and to provide a computer system according to the invention would be within the ability of a man of ordinary skill in the art in view of the following description, unless indicated otherwise, and so has not been described in any detail.

With reference to FIG. 1, there is shown a lost property locating system, designated generally by reference numeral 100, which operates according to the method of the invention. The system includes a server computer 110 hosting a website 112 which is in communication with the Internet 114. In order to utilize the service provided by the system, an owner 120 initially registers their membership of the service with the computer system by accessing the website 112 by using browser software running on an Internet enabled communication device, such as a personal computer 122.

The person 120 that is registered as a member of the lost property locating service is the owner of an item of property such as a cellular telephone 124. The cellular telephone bears a number of identifiers, including a unique serial number 126, a manufacturer's name 128 and a model name or number 129. The serial number may be a unique identifier for the phone and serves as an item identifier. In the event that there is no single unique identifier borne by an item, a unique identifier may be constructed from a combination of identifiers borne by the item.

With further reference to FIG. 2, the owner 120 of the cellular phone registers ownership of the cellular phone with the computer system 110 by transmitting 130 device information, including the unique serial number, manufacturer name and model name to the computer system. The computer system stores the serial number of the item and the further item identifiers, in the form of the manufacturer name and model name, in a searchable central database 140.

In the event that the owner 120 loses the cellular phone 124, a finder 132 of the phone, who has pre-registered their membership with the service, accesses the website 112 over the Internet 114 using browser software via an Internet enabled communications device such as personal computer 134. The finder 132 has pre-registered as a finder user of the lost property service and various details of the finder, including a finder identifier and communication and address information can be stored by the computer system 110.

The finder 132 locates the serial number for the phone which is a unique identifier for that item of property. The finder carries out a search 136 of the database 140 to identify any items registered with the system having the identical serial number. The results of the search of the database are displayed to the finder, but the potential owner's, or owners', identity which is associated with the serial number, is not supplied.

The finder compares the manufacturer and model information on the item found with those recorded on the database for the serial number to validate the serial number. If the make and/or model information does not correspond to that associated with the serial number, then the item may not be the same as the item registered by the user 120. Alternatively, if the serial number and further identifiers match, the finder confirms to the computer system that the registered item has been found.

The computer system then indicates the status of the registered item as found and notifies 150 the owner accordingly.

The computer system includes a further database 145 which stores data indicating serial numbers that has been searched for by a finder and the date of that finder search. Whenever an owner user adds item details to the database, the computer system determines 143 from the stored finder search data whether a search has previously been carried out for the new item identifier that has just been registered with the system. If the item has been searched for recently, then this can be an indication that the item has been fraudulently acquired by the user 120. Further, if the item has been searched for before the user registered as a member of the property locating service, then this is a stronger indicator that the owner may have acquired the property fraudulently. The system can then generate a warning signal 147 to relevant security services.

With reference to FIG. 3, there is shown a schematic diagram illustrating the functions and operations supported by the computer system 110. The computer system hosts a website 112 which can be accessed by owner users and finder users that have pre-registered with the computer system. Owner and finder contact and identification details are stored by the system during the owner and finder registration procedures and accessed as required.

The system includes an engine 142 which stores and retrieves data in various databases, processes data and handles communications between the computer system and the owner and finder users. The system includes a property database 140 having a number of fields storing data items representing an owner identifier 160, an item identifier 162 and data items 164 and 166 representing further item identifiers.

The system includes a finder search database 145 having fields storing data items representing an item identifier 170 and data items 172 indicating the dates of finder searches carried out for that item identifier.

The system also includes an insurer database 180 storing data identifying an owner 182 and property data 184 representing property owned by that owner. The insurer database can include entries grouped by different insurance companies.

An owner user 120 logs onto the website 112, to enter information relating to an item of their property. The computer system maintains an inventory of items for each owner user. The inventory 300 includes data identifying the particular owner user 160 and data items representing the item identifier 162, make and model identifier data items, data items 304 relating to insurance information, and an item status data item 306.

The owner inventory data can be entered and amended by the owner user 120 and can be displayed to the owner user and the data processed and stored by the engine 142.

In order to register an item of property, the owner enters a serial number, or other unique identifier, together with make and model information and any information relating to any insurance policy covering the item. This data is transmitted 130 to the computer system 110 and engine 142 extracts the relevant data items and populates property database 140 with the owner identifier item 160, item identifier 162 and make and model further identifier data items 164 and 166.

The engine can also up-date insurer database 180 by processing insurance data item 304 to determine the insurer for the policy covering the item and populate the relevant insurer database with data relating to the owner and the insured item of property.

On finding an item of property, a finder user can log onto the website 112 to search the property database 140. The finder user 132 enters the serial number of the lost item of property and submits a search request 136 to the website. The property database 140 is searched by item identifier 162 to determine all items registered in the property database having that item identifier. The results of the search 190 are transmitted to the finder user and include the item identifier 162 and make 192 and model 194 information.

It is possible that more than one item will have the same serial number, or that serial numbers have been incompletely or incorrectly registered by owner users. In that case, the make 196 and model 198 information for the further registered item, or items, stored in the property database is also transmitted to the finder user. The finder user then validates the identity of the lost property item by comparing the make and model information with the found item. Once the identity of the item has been validated, the finder user confirms which of the registered items in the search results has been found. Only the serial number and make and model information is supplied to the finder, the identity of the owner is not notified.

The engine 142 processes the confirmation signal from the finder user and, with reference to the owner identifier data 160 corresponding to the item identifier 162 confirmed by the finder user, up-dates the status data item 306 for the item to indicate that the item has been found. The owner user so identified is then notified that the item has been found, and also of the identity and contact details of the finder, so that they can arrange for return of the item of property.

Every time a finder user carries out a finder search on an item identifier, the item identifier and finder search data is recorded in the finder search database 145. When an owner adds an item to their inventory or up-dates details of an item of their property, the engine interrogates the finder search database to determine whether a search has previously been carried out for an item having the same serial number. If a search for the same serial number is identified, the data for that search is determined from data 172 and compared with the current date to see whether the search was carried out within a predetermined “fraud period”.

If the search for the identical serial number was carried out before the owner user registered with the property locating service, then a signal indicating a probable fraud attempt is generated. If the search was carried out after the owner registered with the service, then a signal indicating a less likely fraud attempt is generated. These high and low fraud probability signals can be used to provide security warnings 147 to security staff for monitoring to help identify fraudulent behaviour.

If an owner user makes a claim on an insurance policy to replace a lost item, then the owner up-dates the insurance data 304 in their inventory. The engine processes this data and with reference to insurance database 180 can generate an insurer inventory 210 for each individual insurance company containing data identifying the original owner of the property, policy data and information relating to the property covered by that policy. The insurer inventory indicates to an insurer those items of property which have been found and for which the original owner has already made a claim under the insurance policy such that the insurer is now the owner of that property item.

With reference to FIG. 4, there is shown a flow diagram illustrating aspects of the pre-registration process for the property location service provided by the invention and which are implemented by suitable software. A party wishing to register with the service logs onto the website 112 and selects 410 the account type required. A number of owner user accounts are available. These include an individual owner account 412, a business owner account 422 and an employee owner account 423. An individual owner account can be selected 412 and the individual indicates a preferred service option 414 and completes an individual registration 416 by submitting their name, address and other personal information. This data is stored 418 by the computer system 110 and a unique referral number is assigned to the individuals account.

Similar functions are provided to allow a business to register a business account so that a number of employees of the business can utilise the service. A preferred service is selected 424, a registration form is completed 426 by entering identification and address details of the business, the registration details are stored 428 by the computer system and a unique referral and business number is assigned to the account. The individual or business accounts are marked 420 as having a live status and the account is confirmed 421 by an e-mail. Once a business account has been set up, an employee of the business can set up an individual type account 432 by completing an employee registration form 434 and providing the employer's business number as assigned to the business account by the system. The employees registration details are stored 436 in a database and assigned a unique referral number. The employees account status is then indicated as live 438 and confirmation that the account has been set up is e-mailed to the employee 439 and the employer 440.

A finder user account registration facility is also provided 442 and the party wanting to act as a finder user completes and submits 444 a finder registration form, the details from which are stored in a database and assigned a unique referral number 450. Similarly, insurer account, retailer account and agent account registration facilities are supported and require completion of appropriate registration forms, the details from which are stored in a database and assigned a unique referral number. Confirmation of the accounts being set up is eventually transmitted to the new user.

FIG. 5 illustrates owner user facilities supported by the system and implemented by suitable software. An owner that has registered as an owner user as described previously with reference to FIG. 4, logs onto the website and selects an action 510. The actions available are a manage inventory option 512, a demo search 514, detail up-dating 516, password up-dating 518 and friend notification 519.

Initially, an owner needs to add items to their inventory. The owner user selects the manage inventory option 512 and selects the add item option 524 initiating an “add item” protocol 600 as illustrated by the flowchart shown in FIG. 6. The owner enters item details 610 including one or more serial numbers borne by the item and further item identifiers such as the manufacturer name, the model name or number and any other information borne by the item by which it may be identified. The engine 142 processes the submitted information and stores 612 relevant data items in the property database 140.

The engine also interrogates the finders search database 145 to determine 614 whether a serial number the same as the serial number that was just entered has been searched for within a fraud period. If no finder search for the same identifier within the fraud period is found, the owner user is returned to the manage inventory option. If the engine determines that the same serial number has been the subject of a search by a finder within the specified period, then the engine determines 616 from the search data and the owners stored registration data whether the search was made prior to the member registering with the service.

If the search was made after the member registered with the service, then the likelihood of a fraudulent item entry is considered to be low and the engine generates a signal indicating that status 618. If the search was made before the owner registered with the service, then the likelihood of a fraudulent item registration is considered to be higher and the engine generates a signal indicating this state 620. An e-mail message that a possible or probable attempt to fraudulently register ownership of an item has been made is used to alert nominated persons.

An owner is also provided with item editing and item found processes. Item editing functions 516 allow an item to be deleted from the owners inventory and also to amend details associated with an item in the inventory, such as insurance details for the addition of further item identifiers. The item found operation initiates a find acknowledge protocol 800 which will be described later with reference to FIG. 8.

With reference to FIG. 7, there are shown finder user processes 700 supported by the system and implemented by suitable software. The finder user, having registered with the system as described previously with reference to FIG. 4, logs onto the website 112 once an item has been found. A number of actions 710 are supported including carrying out a search 712, modifying the finder user details 714, changing the finder user password 716 and notifying a friend of the service 718. If a finder selects the search option, a search protocol 720 is initiated. The finder enters a serial number 722 which has been read from the item found. The engine processes the search request and stores 724 details relating to the finder search in the finder search database 145. The engine then searches 726 the property database to cover all owner inventories for serial numbers matching the serial number entered.

If no match is found, then the finder is notified and can select a further action. If a match is identified then the results 190 of the search are displayed to the finder together with the further item identifiers derived from the property database so that the finder can compare the further identifiers with the item to verify 730 the identity of the item found. If there is insufficient data or a conflicting result, then the finder does not confirm the identity of the item found.

If the identity of an item found can be confirmed, then the finder transmits further details 732, such as their location and contact information for the owner. The engine on receiving confirmation of the identity of the item indicates the status of the item as found 734 in the owners inventory. The finders additional information is then e-mailed to the owner 736 so that the owner can contact the finder to arrange for recovery of the lost item.

FIG. 8 illustrates the functions of a found acknowledgement process, designated generally by reference numeral 800, supported by the system and implemented by suitable software. When engine 142 supplies a notification that an inventory item has been found, the owner can notify the system of a number of scenarios in relation to that item. The owner can indicate 802 that the item has been returned by the finder, and the engine removes the found notification 804 and up-dates 806 an indication of the number of successful finds associated with a finder user.

If the item has been the subject of a claim under an insurance policy, then the owner can indicate this to the system 810, and the engine up-dates 812 an insurer inventory 210 with the item information. The engine also adds a found notification 814 to the insurer inventory and notifies 816 the insurer that the item has been found.

The owner user can also indicate that the item indicated was never lost 820. The found notification is removed 822 from the owner inventory and the finder user is informed 824 that there has been a mis-identification; ie that the found item is not the item registered in the system.

The system is particularly suitable for instances where a unique serial number is associated with the item of property. However, a combination of identifiers borne by the item may in combination provide a unique identifier for the item. The system and method allows for lost property which has been registered with the system to be located by the original owner in a secure manner and includes features to help identify fraudulent claims to lost property. As the finder and owner use a common service, the time and location of loss of the item is immaterial which obviates the difficulties associated with previous geographically based facilities.

1. A computer implemented lost property locating method by which an owner of an item of lost property bearing an item identifier which is found by a finder can be notified that the item has been found, the method including the steps of:
the owner registering the item identifier with a computer system;
the finder searching the computer system for the item identifier to determine if an item having the item identifier has been registered; and
the computer system notifying the owner that the item has been found if the item identifier is found.

2. A method as claimed in claim 1, in which the computer system is accessible over the internet.

3. A method as claimed in claim 1, in which the owner registers at least one further item identifier.

4. A method as claimed in claim 3, in which the at least one further item identifier is selected from a manufacturer identifier, a model identifier, a colour identifier and a trade mark identifier.

5. A method as claimed in claim 3, and including the step that if the item identifier is found, the finder determines whether the at least one further item identifier corresponds to the item found, and if not the computer system does not notify the owner.

6. A method as claimed in claim 1, and including the step of the owner notifying the computer system that the item notified was not lost and the computer system notifying the finder that the lost item has been misidentified.

7. A method as claimed in claim 1, and including the step of the owner notifying the computer system that the lost article has been replaced under an insurance policy, and the computer system updating an insurance record for the article.

8. A method as claimed in claim 7, and including the step of the owner supplying insurance data to the computer system and the computer system recording the insurance company associated with the insurance data as the owner of the property.

9. A method as claimed in claim 1, in which the step of registering the item identifier includes determining whether the item identifier has been the subject of a finder search by a finder within a specified period, and if it has then the computer system generating a possible fraudulent registration signifier.

10. A method as claimed in claim 9, and including the step of determining if the finder search was carried out before the owner registered membership with the computer system, and if it was, generating a probable fraudulent registration signifier.

11. A computer implemented lost property reclaiming system, in which an owner of an item of lost property bearing an item identifier which is found by a finder can be notified that the item has been found, the system including, processing means and a searchable database of item identifiers, in which:
the owner transmits the item identifier to the computer system which stores the item identifier in the database;
the database is searchable by an item identifier by the finder to carry out a finder search to determine if an item having the item identifier has been registered; and
the processing means notifying the owner that the item has been found if the item identifier is found by the finder search.

12. A computer readable medium bearing instructions executable on a computer to carry out a method as claimed in claim 1 or to provide a system as claimed in claim 13.

13. A computer program executable on a computer system to carry out a method as claimed in claim 1 or to provide a system as claimed in claim 11.
